(19) United States
(12) Patent Application Publication
(10) Pub. No.: US 2024/0173844 A1
(43) Pub. Date: May 30, 2024

(54) ROBOTICS ASSISTED OPENING SYSTEMS AND METHODS

(71) Applicant: UNIVERSITY OF HOUSTON SYSTEM, Houston, TX (US)

(72) Inventors: Zheng Chen, Sugar Land, TX (US); Wenyu Zuo, Houston, TX (US); Gangbing Song, Pearland, TX (US); John Allen, Houston, TX (US)

(73) Assignee: UNIVERSITY OF HOUSTON SYSTEM, Houston, TX (US)

(21) Appl. No.: 18/283,738

(22) PCT Filed: Mar. 10, 2022
(86) PCT No.: PCT/US2022/019720

§ 371 Date: Sep. 22, 2023

Related U.S. Application Data
(60) Provisional application No. 63/166,090, filed on Mar. 25, 2021.

(51) Int. Cl. B25J 5/00; B25J 15/10

(52) U.S. Cl. CPC B25J 5/007; B25J 15/10

(57) ABSTRACT

A force application system for placement on and removal from an actuable latch with a robotic arm includes a driving pad configured for attachment to the actuable latch, a force application mechanism configured to increase an input force to an amplified output force that is applied by the force application mechanism to the driving pad, and a frame for engagement by the robotic arm.

### CROSS-REFERENCE TO RELATED APPLICATIONS

The present application claims the benefit of U.S. Provisional Patent Application No. 63/166,090, filed on Mar. 25, 2021. The entirety of the aforementioned application is incorporated herein by reference.

### STATEMENT REGARDING FEDERALLY SPONSORED RESEARCH

This invention was made with government support under Grant No. 582-15-57593 awarded by the Texas Commission on Environmental Quality Subsea Systems Institute. The government has certain rights in the invention.

### BACKGROUND

A need exists for robotic systems and methods that more effectively operate an aperture closure between an aperture open state and an aperture closed state. Numerous embodiments of the present disclosure address the aforementioned limitations.

### SUMMARY

An exemplary force application system for placement on and removal from an actuable latch with a robotic arm includes a driving pad configured for attachment to the actuable latch, a force application mechanism configured to increase an input force to an amplified output force that is applied by the force application mechanism to the driving pad, and a frame for engagement by the robotic arm.

An exemplary method includes attaching, with a robotic arm, a force application tool to an actuable latch on a closure, where the force application tool includes a driving pad attached to the actuable latch, a force application mechanism operable to increase an input force to an amplified output force applied to the driving pad, applying the input force to the force application mechanism, moving the actuable latch to an unlocked position in response to the amplified output force, and moving the closure with the robotic arm to open a pathway.

An exemplary method of operating an aperture closure between an aperture open state and an aperture closed state includes (1) using a system of the present disclosure; (2) actuating the at least one gripper of the robotic arm to place the force amplifier on the latch of the closure; and (3) actuating the robotic arm to actuate the force amplifier to amplify a force, where the amplified force moves the latch and thereby facilitates the operating of the aperture closure of the enclosure between an aperture open state and an aperture closed state.

### BRIEF DESCRIPTION OF THE DRAWINGS

FIG. 1A show a robotic system and a force amplifier in accordance with embodiments of the present disclosure.

FIG. 1B illustrates an exemplary pawl assembly of an exemplary force amplifier tool.

FIG. 1C is a block diagram of an exemplary method for operating an aperture closure.

FIGS. 2A-2F illustrate an exemplary method of using a robotic system to open a door in accordance with embodiments of the present disclosure. FIG. 2A illustrates a robotic arm holding a force amplifier tool and attaching the force amplifier tool to a door latch. FIG. 2B illustrates the robotic arm gripping a force input arm of the force amplifier tool to apply an input force to the force amplifier tool. FIG. 2C illustrates the robotic arm removing the force amplifier tool from the door latch. FIG. 2D illustrates the robotic arm gripping the door without the force amplifier tool. FIG. 2E illustrates the robotic arm moving the door to an open position. FIG. 2F illustrates the robotic arm moving through the open doorway.

FIG. 3A illustrates an exemplary aperture closure in the form of a watertight door. FIG. 3B illustrates the watertight door of FIG. 3A from an opposite side revealing the locks. FIG. 3C is an expanded view of an exemplary lock in an unlocked position. FIG. 3D is another expanded view of an exemplary lock in the locked position.

FIGS. 4A-4B illustrate a robotic system and its control diagram. FIG. 4A illustrates an exemplary robotic system having a gripper, a robotic arm, and an unmanned ground vehicle (UGV). FIG. 4B is an exemplary control diagram for controlling the robotic system.

FIGS. 5A-5B illustrate an exemplary gear force amplifier tool design. FIG. 5A illustrates a spur gear set for a gear force amplifier tool. FIG. 5B illustrates an exemplary gear force amplifier tool.

FIGS. 6A-6C illustrate aspects of an exemplary wrench force amplifier tool. FIG. 6A illustrates an exemplary pawl mechanism. FIG. 6B illustrates an exemplary robotic system with a wrench force amplifier tool. FIG. 6C illustrates an exemplary wrench force amplifier tool.

FIGS. 7A-7B are schematic illustrations of a kinetic analysis of an exemplary robotic system and force amplifier unlocking a door. FIG. 7A is a front view and FIG. 7B is a side view.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials define a term in a manner that contradicts the definition of that term in this application, this application controls.

Robotic systems have found applications in opening and closing numerous closures, such as doors. For instance, robotic systems that include unmanned ground vehicles (UGVs) and a robotic arm have been utilized to open and close doors in numerous places, such as factories.

However, robotic systems have limited capacities in opening and closing more complex closures due to their limited operational range, strength, and leverage. In particular, numerous factors affect a robotic system's ability to open and close closures. Such factors include: the environmental and physical conditions that affect the closure's opening and closing mechanism; temperature and pressure conditions that can cause a closure to expand, thereby leading to stronger applied pulling or pushing forces; and the complexity of the closure, including its size and functionality.

For instance, doors vary in design and function depending on their application. Some doors are mounted on hinges to be swung open while others are mounted on sliding rails. More sophisticated doors, such as revolving doors and airlock doors, take advantage of both sliding and pivoting mechanisms as well as multiple locking systems. While some doors utilize a simple mechanism of pivoting a handle, others may require multi-step processes. Additionally, many doors, such as pressurized doors and/or watertight ship doors, may be too tight for opening by a lightweight robotic system.

Many studies have focused on improving robotic systems in order to open different types of doors. However, such studies have primarily focused on investigating how to use robots to open home doors, which are lightweight and have simple structures. Opening a door with a knob lock requires appropriate end effector torque output to rotate the knob, which is a considerable simple task that only involves one degree of freedom (DOF) motion. Focus is also placed on torque control and finger pose control in opening a door with a knob lock.

Numerous studies have also focused on inverse kinematics for using robotic systems to open doors. In some cases, a robotic arm needs help from a UGV to open a door, and a UGV can provide an extra pull or push force to move the door. When opening the door, carrying out a curved movement sometimes requires simultaneous cooperation between the robotic arm and the UGV.

However, robotic systems with UGVs may not have sufficient leverage, strength, and torque output to open many enclosures. For instance, in order to open a watertight ship door, the first challenge is to generate enough torque to rotate a wheel to unlock the door. However, a standard robotic arm on a UGV would be unable to address the aforementioned challenge.

Studies have aimed to address the aforementioned challenges by focusing on modified robotic arm grippers in order to more effectively open and close doors. See, e.g., S. Kobayashi et al., “Development of a door opening system on rescue robot for search “umrs-2007”,” in Proc. of 2008 SICE Annual Conference. IEEE, 2008, pp. 2062-2065. However, such modified grippers affect the versatility of robotic arms for use in alternative applications. Furthermore, such modified grippers remain unable to open and close more complex enclosures, such as watertight ship doors.

As such, a need exists for robotic systems and methods that more effectively operate an aperture closure between an aperture open state and an aperture closed state. Numerous embodiments of the present disclosure address the aforementioned limitations.

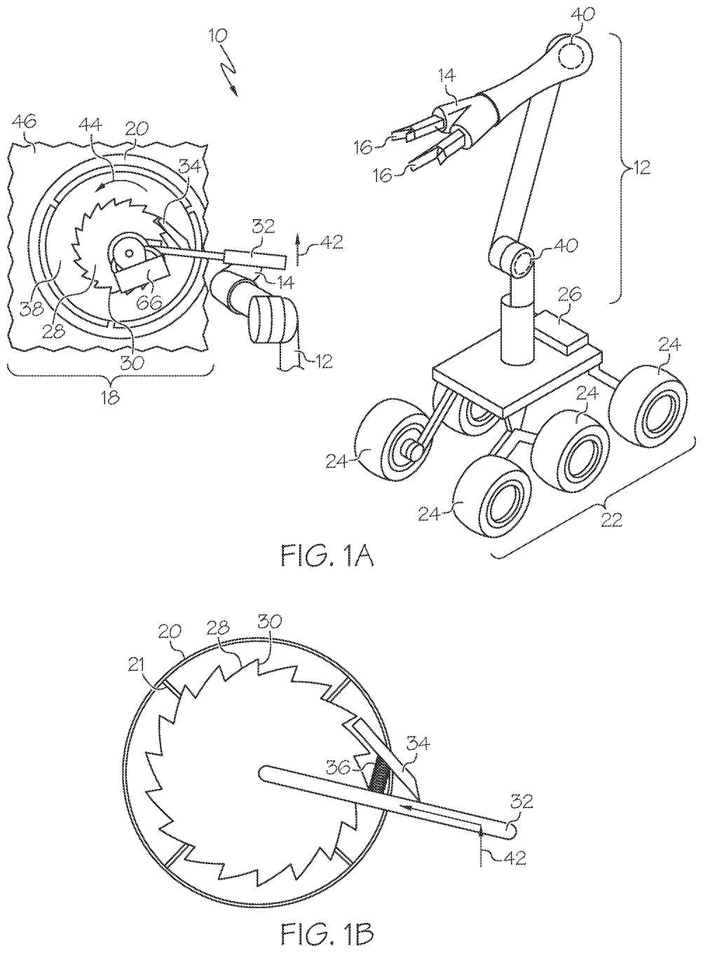

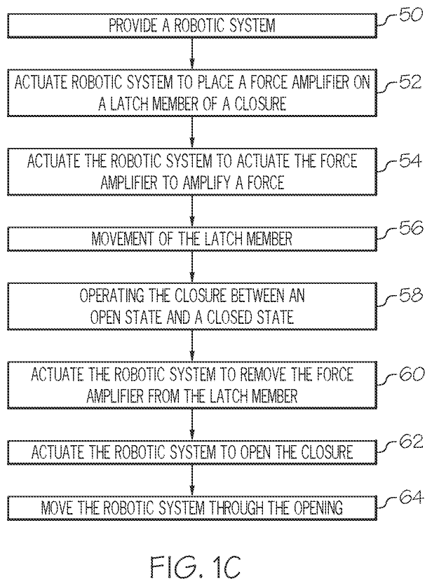

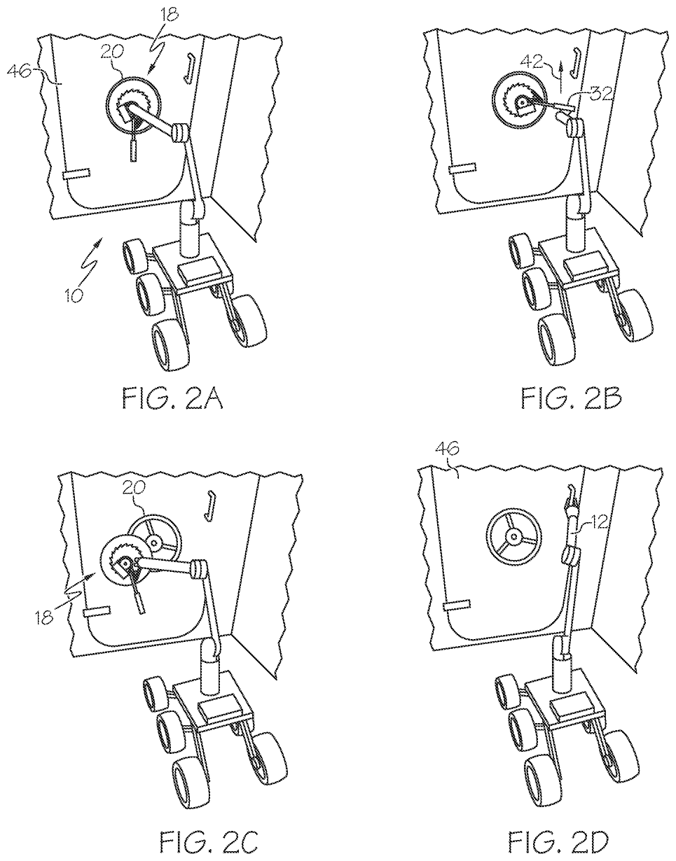

An example of a system of the present disclosure is illustrated in FIG. 1A as system 10. System 10 includes robotic arm 12 which may include a gripper 14 which may include one or more fingers 16. Fingers 16 may be articulatable members or static members forming a saddle or recess. Robotic system 10 includes a force amplifier 18 which may be used by the robotic arm to amplify an input force from the robotic arm. Robotic arm 12 may include one or more interconnected links 13. Robotic arm 12 includes one or more actuators 40, e.g., electric or hydraulic motors, operable to move the robotic arm and apply an input force 42 to force amplifier 18. Force amplifier 18 increases input force 42 to an amplified output force 44.

Force amplifier 18 is separate unit from robotic arm 12 and is functionally engageable with robotic arm 12, and selectively connectable by robotic arm 12 to actuatable latch 20 of an aperture closure 46. Force amplifier 18 is operational to be attached to latch 20 by robotic arm 12 and actuated by the robotic arm to amplify the input force 42 to an increased output force 44 to move latch 20 to an unlocked position and thereby facilitate operating closure 46 between an aperture open state and an aperture closed state. In an exemplary embodiment, force amplifier 18 is a tool that mechanically amplifies the input force.

In an embodiment, system 10 includes a support base 22 for supporting robotic arm 12 and force amplifier 18. In the illustration shown in FIG. 1A, support base 22 is in the form of an unmanned ground vehicle, which has a plurality of wheels 24 and an electrical system 26 for receiving remote control signals.

As illustrated in FIGS. 1A and 1B, an exemplary force amplifier 18 is in the form of a ratchet and pawl system that includes a ratchet wheel 28 with a plurality of rims 30. Ratchet wheel 28 is operational for rotating in at least one direction to apply the output force 44. A rod 32 for receiving the input force extends radially from the ratchet wheel and includes a pawl 34 engageable with rims 30 to rotate the ratchet wheel in one direction, for example counterclockwise. In this example the rod can be moved clockwise without the pawl engaging the rims thereby allowing the rod to be relocated to a desired position. The ratchet and pawl system includes a spring 36 coupled to pawl 34 to maintain coupling between pawl 34 and rims 30.

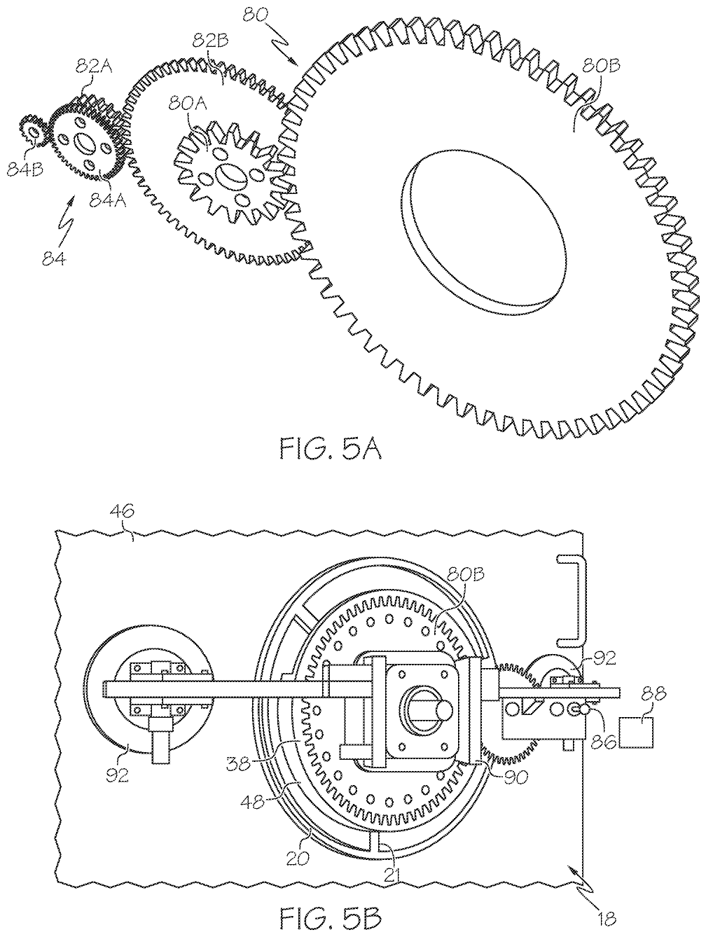

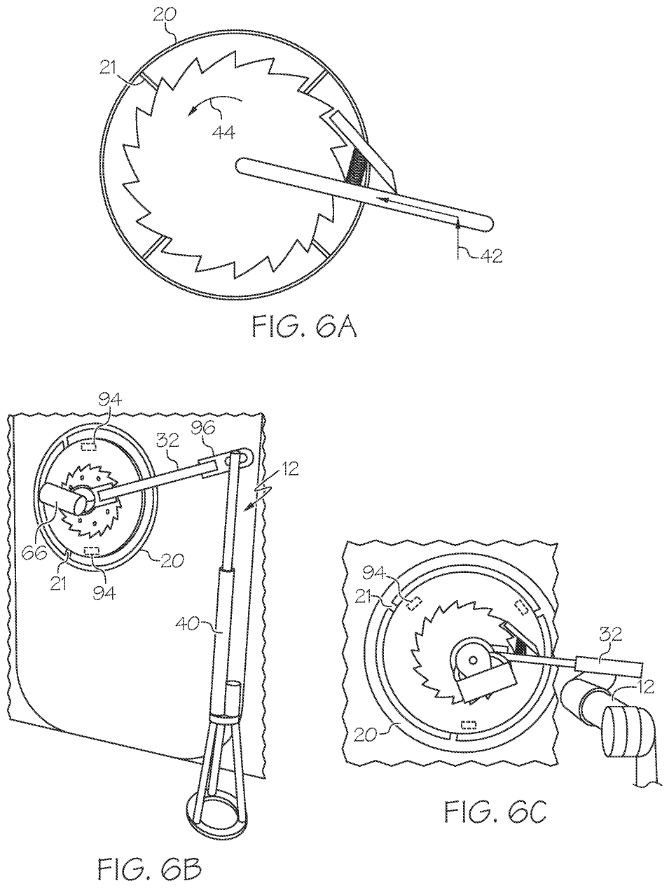

Force amplifier 18 includes a driving pad or frame 38 that is connectable to latch 20. Pad 38 is rotationally stationary with ratchet wheel 28 to transfer the rotational output force to latch 20. Pad 38 may include teeth 48 (FIG. 5B) to engage latch 20, for example the spokes 21 of latch 20. Pad 38 may include magnets 94 (FIGS. 6B, 6C) to facilitate attaching the force amplifier to latch 20. Force amplifier 18 includes a handle 66, for example on the opposite side of pad 38 from the latch, for gripping with the robotic arm for placing the pad and force amplifier on the latch 20 and for removing the pad and force amplifier from the latch. Handle 66 may be a frame portion of the force application tool.

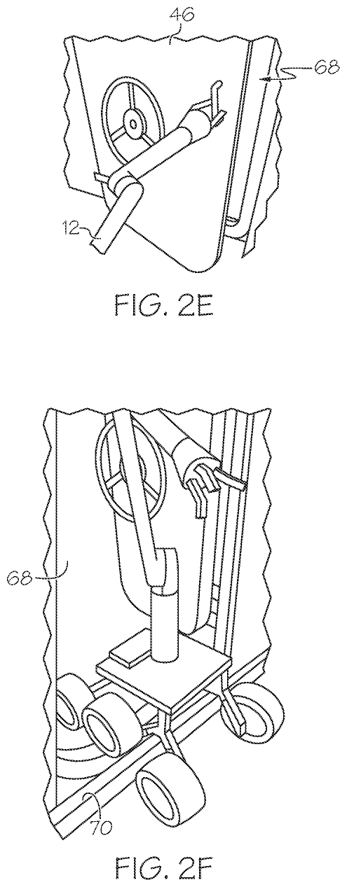

An exemplary method, illustrated in FIG. 1C, includes, at block 50, using a system 10 including a robotic arm 12 and a force amplifier 18 to operate an aperture closure. At block 52, the robotic arm is operated to place the force amplifier on a latch of the closure. For example, gripper 14 engages handle 66 and the robotic arm is manipulated to position pad 38 on the latch 20 whereby the teeth are between spokes of the latch. At block 54, the robotic arm is disengaged from handle 66 and positioned in contact with rod 32 and the robotic arm is actuated to apply an input force 42 via rod 32 to the force amplifier and the force amplifier increases the input force to an amplified output force 44 and the force amplifier applies the amplified output force to the latch. At block 56, the latch moves in response to the amplified output force. At block 58, the closure is operated to an aperture open state in response to the moving, e.g., rotating, the latch to an unlocked position. In some embodiments, the method includes actuating the robotic arm to remove the force amplifier from the latch (block 60). In some embodiments, the method includes using the robotic arm to move the closure and open the closure aperture (block 62). The closure may be moved with the force amplifier on the latch or removed from the latch. At block 64, the exemplary method includes moving the robotic arm through the open aperture 68 (FIG. 2F).

As will be understood by those with skill in the art with benefit of this disclosure, the system may be used to close and secure an aperture closure as well. For example, the robotic arm may be operated to move (swing or slide) the closure into a closed position blocking the aperture. The robotic arm may be operated to engage the force amplifier with a latch of the closure, for example a rotational latch. The robotic arm may be actuated to operate the latch from an unlatched position to a latched position for example by applying an arm force to the force amplifier which amplifies the arm force to an amplified force that is applied to the latch.

FIGS. 2A-2F illustrate an exemplary method of operating an aperture closure 46 between an aperture open state and an aperture closed state through the utilization of system 10. In this embodiment, the closure 46 is a watertight door, and the system is described with reference to FIGS. 1A-1B. First, the robotic arm 12 places a force amplifier 18 on latch 20 of watertight door 46 (FIG. 2A). Robotic arm 12 may hold force amplifier 18 by handle 66 when placing the force amplifier on the latch 20. Next, with the force amplifier attached to latch 20, the robotic arm actuates the force amplifier by applying an input force 42 to rod 32 of the force amplifier. The force amplifier increases the input force to an amplified output force that moves, e.g., rotates, the latch of the door to an unlatched position and thereby facilitates the operating of the door (FIG. 2B). In FIG. 2C, the robotic arm may remove the force amplifier from the latch of the door. FIG. 2D illustrates the robotic arm gripping the door and in FIG. 2E the robotic arm has been manipulated to move the door 46 thereby opening the closure aperture 68. FIG. 2F illustrates the robotic arm moving through the open doorway 68 and passing over a raised threshold 70.

Robotic arms generally refer to mechanical devices with motor-powered joints that are able to utilize the motor-powered joints to move in desired directions. For instance, a robotic system can utilize robotic arms to operate exterior facilities and tools for a specific task. The methods and systems of the present disclosure can utilize various types of robotic arms.

For instance, in some embodiments, the robotic arms of the present disclosure include a gripper. In some embodiments, the gripper is operational to place a force amplifier on a latch and operate the force amplifier. In some embodiments, the gripper includes one or more grip fingers. In some embodiments, the gripper includes at least three grip fingers.

The robotic arms of the present disclosure can have various functions. For instance, in some embodiments, at least one gripper of a robotic arm may be utilized in accordance with the methods of the present disclosure to place a force amplifier on a latch of a closure. In some embodiments, the robotic arm may then be utilized to actuate the force amplifier to amplify a force that moves the latch and thereby facilitates the operating of the closure between an aperture open state and an aperture closed state.

In some embodiments, the methods of the present disclosure also include actuating the robotic arm of the system to remove a force amplifier from a latch of a closure. In some embodiments, the removal occurs after the operating of the closure between an aperture open state and an aperture closed state.

In some embodiments, the methods of the present disclosure include actuating the robotic arm to move the closure to open the enclosure. In some embodiments, the methods of the present disclosure also include moving the robotic system through the closure aperture.

Force amplifiers generally refer to devices that are operational to amplify a force. In some embodiments, the force to be amplified includes torque. In some embodiments, the force amplifier may be operational to amplify the torque.

In some embodiments, the force amplifier helps overcome a mechanical power output insufficiency of a robotic arm. In some embodiments, the force amplifier is operational to utilize a small force to generate a large torque.

The methods and systems of the present disclosure can utilize various types of force amplifiers. In some embodiments, the force amplifiers of the present disclosure represent system components that are separate from robotic arms. In some embodiments, the force amplifiers of the present disclosure are detachable from robotic arms. In some embodiments, the force amplifiers of the present disclosure are not embedded with robotic arms. In some embodiments, the force amplifiers of the present disclosure represent system components that function independently from robotic arms.

Due to being separate from robotic arms, the force amplifiers of the present disclosure can be utilized in accordance with the methods of the present disclosure without a need to modify existing robotic arms with force generation components. As such, the force amplifiers of the present disclosure can be operated by standard robotic arms that lack force generation components.

In some embodiments, the force amplifiers of the present disclosure are compact. For instance, in some embodiments, the force amplifiers of the present disclosure are in the form of a handheld device.

In some embodiments, the force amplifiers of the present disclosure are operational to move a latch in incremental turns. In some embodiments, the force amplifiers of the present disclosure are operational to divide a circular motion into multiple repetitive linear motions. In some embodiments, the force amplifiers of the present disclosure are operational to rotate a latch about a rotational axis.

In addition to a robotic arm and a force amplifier, the systems of the present disclosure may include additional components. For instance, in some embodiments, the systems of the present disclosure also include a support base that is operational for supporting the robotic arm and the force amplifier.

In some embodiments, the support base is operational for engaging a resisting surface in operational proximity to an enclosure. In some embodiments, the engagement of the support base with the resisting surface supports a reaction force in opposition to an amplified actuating force. In some embodiments, the reaction force further facilitates movement of the system at least one of prior to, during, subsequent to, and combinations thereof, within the operational proximity to the enclosure.

The support bases of the present disclosure may be in various forms. For instance, in some embodiments, the support bases of the present disclosure are in the form of a mobile platform. In some embodiments, the mobile platform is in the form of a remotely operated vehicle (ROV). In some embodiments, the remotely operated vehicle is in the form of an unmanned ground vehicle (UGV). In some embodiments, the remotely operated vehicle is in the form of an underwater vehicle.

The support bases of the present disclosure may have various components. For instance, in some embodiments, the support bases of the present disclosure also include one or more hydraulic lifts operational to adjust a height of the support base. In some embodiments, the support bases of the present disclosure include an electrical system for receiving remote control signals.

In some embodiments, the systems of the present disclosure may also include a user control interface. In some embodiments, the user control interface is operational to allow a user to remotely control the robotic arm.

Closures generally refer to a barrier member for closing an aperture and that is operable to be in an open state and a closed state. In some embodiments, the closures separate two spaces for the purpose of safety. In some embodiments, the closures require an operation to switch from an open state to a closed state.

For instance, in some embodiments, the closure includes a hatch. In some embodiments, the closure includes a valve. In some embodiments, the closure includes a door. In some embodiments, the closure is a pressurized barrier. In some embodiments, the closure is a watertight barrier. In some embodiments, the watertight barrier is a component of an underwater vessel, such as a submarine.

The closures of the present disclosure may also include various types of latches. For instance, in some embodiments, the latch is a rotatable wheel. In some embodiments, the latch comprises rotatable spokes. In some embodiments, the latch is a doorknob. In some embodiments, the latch includes a valve lever.

The systems and methods of the present disclosure may operate closures in various manners. For instance, in some embodiments where the closure is in an aperture open state, the methods and systems of the present disclosure may be utilized to place the closure in a closed state. In some embodiments where a closure is in an aperture closed state, the systems and methods of the present disclosure may be utilized to place the closure in an open state.

Recent offshore drilling activities have dramatically bloomed oil and gas production. Due to some extreme weathers, such as hurricanes, offshore oil platforms should be able to work under an unmanned operation mode. Applicant describes the development of a robotic system with an unmanned ground vehicle (UGV) component which can pick up a force amplifier tool, open a watertight ship door, and transition through the door with a remote control.

Given the watertight door's unique structure, Applicant designed door opening (unlocking) tools and a mobile platform to help the robotic arm complete the work. Applicant verified the possibility of the deploying the robotic system in the offshore oil industry and enhancing its adaptability.

After a door is opened, the second challenge is to transition through the door. The robotic system had a design requirement of crossing over a 9 cm high door threshold and turning within a compact space. The robotic system demonstrated a strong ability to overcome obstacles and achieve skid turning. With a wireless control system and high torque motor, the robotic system could carry the robotic arm and move freely. In opening the door, the robotic arm was first used to pick up and install the force application tool on to a door latch. Then the arm's orientation was manipulated to apply an input force to the force application (e.g., force amplification) tool, after which the tool was removed from the door latch. During the process, the robotic system was continuously maneuvered to help the robotic arm reach the best position.

The UGV component of the robotic system also provided extra help to drag and push when the robotic arm was performing another function. In the end, the UGV with the attached robotic arm made its way across the door threshold. This combined robot system was able to demonstrate the ability to open a quick-action watertight door without any human intervention.

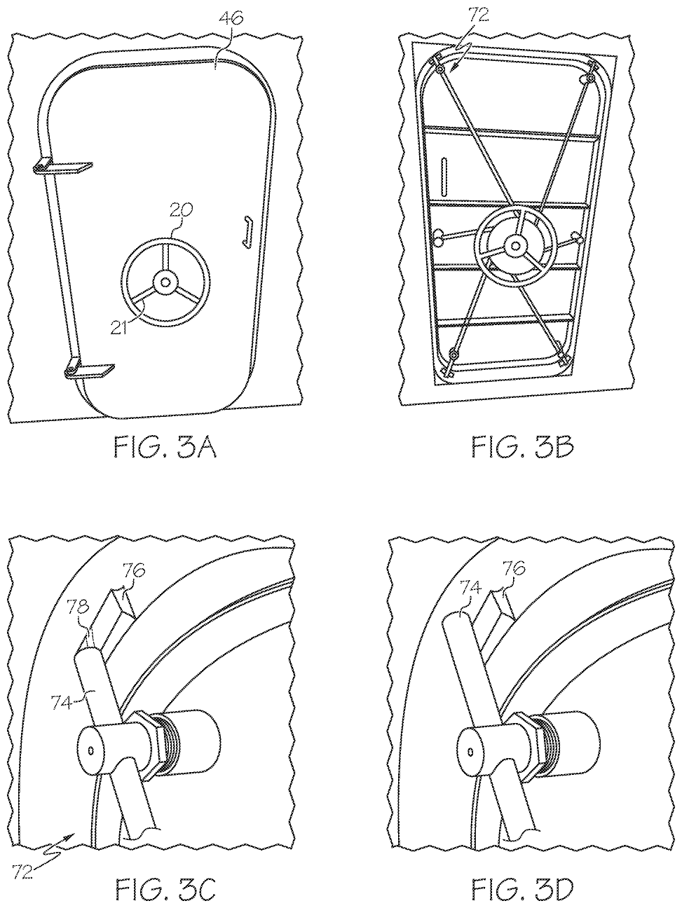

With reference to FIGS. 3A-3D an exemplary closure 46 in the form of a watertight door has a quick action lock or latch, which includes a wheel handle 20 (e.g., latch) and dog locks 72 (FIG. 3B). The dog lock 72 is specifically designed for the sealing the door when the dog lock is engaged. Turning the wheel 20 in the locking direction extends the dog lock arm 74 from the unlocked position (FIG. 3C) to a locked position (FIG. 3D) with dog lock arm 74 engaged with the wedge 76. Dog lock arm 74 impacts wedge 76 at an inclined surface 78, which makes part of the compression work vertically to let the door squeeze the rubber gasket.

With the dog lock. the watertight door squeezes the rubber gasket and insulates the inside space from outside. The door's dimension is 0.8 m×1.6 m, with a mass of 400 kg. The torque needed to turn the wheel is 33 Nm, which was measured by a valve wrench and force gauge.

The frame has a 9 cm thread. To open the door, the wheel needed to be turned counterclockwise from the outside. As long as the dog and wedge were untouched, the door popped out slightly due to the rubber gasket's elasticity, allowing the door to be pulled open easier. The majority of torque is needed to overcome the friction between dog and wedge. Friction is strengthened from the elastic force as a consequence when squeezing the rubber gasket.

A major challenge to opening a watertight door with the robotic arm is the force limitation. The door's wheel was designed to enlarge the distance so that humans can operate using both hands with less force. However, the robotic arm's wrist and finger were driven by a separate actuator. The robotic arm's finger's force was insufficient to open the door.

Additionally, requiring the robotic arm to make a circular motion by manually controlling it is a challenge. Increasing the distance between the latch's rotational axis and the robotic arm was a key point to overcome force limitation. Devices were invented to work as a wrench to connect the door's wheel latch and the robotic arm. These force application tools can be stably attached to the wheel handle and can be rotated. Additionally, the devices enlarge the distance between the robotic arm and the wheel's rotating axis. Further, the devices are light and easy for the robotic arm to grasp.

In addition to the force limitation on the robotic arm, the door threshold presents challenges for a mobile platform. The robot in this trial needed to cross a 9 cm door threshold. Thus, the robotic system's structure has to be intelligently designed and qualified with sufficient power. Accordingly, the overall strategy included designing a door opening tool and a robotic system with a UGV.

A KINOVA Ultra lightweight robotic arm was nominated to handle the door opening. The robotic arm has 4 degrees of freedom (DOFs) and a three-finger gripper. The twist and finger has very limited load capacity. The first joint and second joint of the robotic arm is powered by a KA-75 motor, which has 30.5 Nm maximum torque. The robotic arm's total weight is 4.2 kg, and its maximum reach range is 0.75 m.

A requirement of the UGV was to cross over a 9 cm high obstacle carrying the robotic arm. The NASA's six wheeled rover concept was adopted to the original design using suspensions for the front wheels. Each tire was driven by a 30-rpm gear motor, which could output a maximum torque of 0.39 Nm. The mobile platform can climb over up to 0.15 m high obstacles with its 0.3 m diameter all-terrain tire and rover suspension. With parallel sets of wheels, the mobile platform can achieve skid steering by oppositely controlling the wheels on both sides.

The skid steering was an important ability to guarantee the mobile platform's maneuverability in a compact area. The ability also extends the robotic arm's reachability. The total weight of the mobile platform with a robotic arm was 7.2 kg.

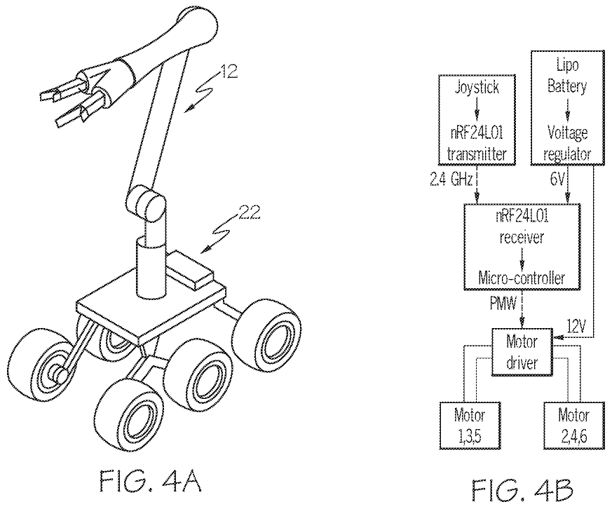

The robotic arm was installed on the top of the platform (FIG. 4A). In FIG. 4B, the UGV was manually controlled by a remote joystick controller. The controller communicated with the mobile platform's micro-controller through a nrf24 radio transmitter. The micro-controller translated the motion command into the Pulse-Width-Modulation (PWM) signal and was distributed to three L298n H-bridge motor drivers. Three motors on one side of the UGV shared the same signal. Two 14.8V Lipo batteries with voltage regulators provided power for both control circuit and motor drivers.

Two different door opening tools were designed and fabricated to operate the door's latch (wheel). Both tools were equipped with a turning or driving pad 38. The exemplary turning pad has three teeth 48 that can be inserted between spokes 21 in the door's wheel 20, and the tool turns the wheel by pushing the spokes. The turning pad also provides a feasible base for the torque amplifying mechanism.

One force application tool uses gears, illustrated for example in FIGS. 5A and 5B, and the other uses a wrench mechanism, illustrate for example in FIGS. 1A, 1B, and 6A-6C to amplify an input force to an amplified output torque.

With reference to FIGS. 5A and 5B, the gear force amplifying tool 18 has three spur gear sets 80, 82, 84, as shown in FIG. 5A. The gears produced a 38.4 overall gear ratio, which amplified the input torque 38.4 times. The output gear set 80 has a diameter pitch of 6 and a 16-toothed gear 80A and a 64-toothed gear 80B. The 64-toothed gear, the larger of the two, was fixed with the driving pad 38 with screws. It had a similar size to the driving pad in order to effectively transmit the torque. The middle gear set 82 has a diameter pitch of 12 with a 20-toothed gear 82A and a 64-toothed gear 82B. The input gear set 84 has a diameter pitch of 24 and a 45-toothed gear 84A and a 15-toothed gear 84B. The gear sets are concentric. The input gear set 84 is connected a hex shaft 86 that is driven by an external motor 88. In an exemplary embodiment, the robotic arm operates motor 88 to apply the input force. In some embodiments, the robotic arm attaches the external motor 88 to shaft 86. The gear tool unlocked the door with a BLACK & DECKER 20V cordless, 12 Nm-torque driver in the test.

Three gear sets were arranged with increasing diameter pitch to make sure the motion from a thin shaft could be transmitted smoothly to a large driving pad. Among these gears, the largest 6-64 gear was made of acrylic and cut by a Roland MDX540 milling machine. The input 24-15 gear was made of copper and purchased online. The other gears were 3D printed in PLA material by an Ultimaker 3 printer. All of the gears were designed by the Toolbox in SOLIDWORKS Education 2019.

In addition to the gear, a 20-mm aluminum frame 90 was built with linear rails bolted with aluminum connectors. Other frame parts were 3D printed by PLA material. A pair of IMT 6 suction cups 92 with a maximum 30 kg load per cup was installed at both ends of the frame to help secure the tool. Frame 90 may be used by the robotic arm to hold the force application tool place it on and remove it from the latch.

An exemplary wrench or ratchet and pawl type force amplifier tool is described with reference to FIGS. 1A, 1B, and 6A-6C. The wrench force application tool extends the force-distance with a rod to amplify the torque, or force applied from a robotic arm. There are two aspects of the wrench tool in realizing this goal. First, the wrenching tool is to be firmly attached to the door's wheel latch 20 by itself since there is no extra device to provide support. Second, the wrench tool is adaptive to any spoke 21 location, and the rod 32 was able to rest horizontally, waiting to be lifted up to open the door from the outside.

The first point may be addressed by adding magnets 94 (FIGS. 6B, 6C) on the pad teeth 48 (FIG. 5B). The magnets can fix the pad with the spokes and prevent the pad from falling when pushing the spokes. The second point was addressed by developing a pawl mechanism to move the rod. In this way, the rod can be relocated clockwise to any position and still push the wheel counterclockwise to apply an output force. The wheel can be turned by linear input motion with the help of a pawl mechanism.

Given that the latch wheel's effective turning angle is ranged from 15 to 45 degrees due to the clearance, the pawl mechanism can divide that large circular motion into multiple linear repetitions around a certain position. After a short linear motion drives the wheel to turn counterclockwise, the linear motion is reversed, and the spring can drag the pawl to the latter ratchet rim. Thus, the linear motion can turn the wheel counterclockwise again.

In FIG. 6B, the robotic arm 12 uses a linear actuator 40. Most of the tool parts were fabricated by the 3D printer, excluding the aluminum linear rod. The linear push, executed by a linear actuator, which has 0.3 m stroke and 900 N maximum load. A slot mechanism 96 connects the linear actuator and rod 32. In the experiment, the linear actuator was able to easily unlock the door.

To further simplify the tool design, an alternative approach that directly used the robotic arm to push the wrench tool was implemented (FIGS. 1A, 1B, 6C). The robotic arm was equipped with two KA-75 actuators which outputted up to 60 Nm torque. Thus, the robotic arm was able to provide sufficient input force to the force amplifier to turn the wheel latch.

The whole door opening process includes 3 steps. The first step is to pick up and install the force amplifier tool. The robotic arm needs to pick up and firmly hold the force application tool. The challenge in this step is that the driving pad needs to be perpendicular to the wrist for easier installation. A large handle 66 (FIGS. 1A, 6B, 6C) is located at the center of the force application tool for the robotic arm to pick up and install the tool. During the installation, the robotic arm needs to align the driving pad 38 with the wheel 20, which may require frequent adjusting of the robotic arm's posture. As long as the pad 38 is aligned, the UGV is able to push forward, and the force application tool can be attached to the wheel latch. After fixing the force application tool on the latch, the robotic arm turns the rod clockwise to prepare for lifting.

The second step is to unlock the door and remove the tool. The robotic arm lifts the rod with the wrist. After unlocking, the gripper may grasp the tool's handle to detach it from the wheel handle.

The third step is to open the door and drive through. The gripper may grasp a small grip handle on the door, and the UGV gradually move back to pull the door and open the doorway. The UGV can pass through doorway and over the threshold.

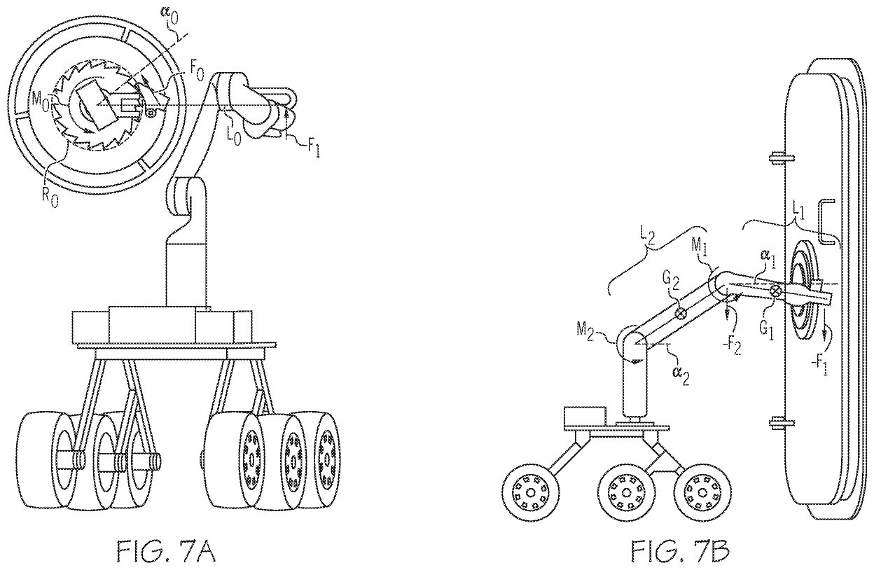

Among these steps, unlocking the door posed the biggest challenge. The robot required a proper angle to exert force controlled. The robotic arm's posture with the wrench tool's position is described with reference to FIGS. 7A and 7B. The definition and magnitude of indexes in FIGS. 7A and 7B are listed in Table I.

TABLE 1
Indexes in FIGS. 7A and 7B.

| Index | Description | Magnitude | |
|---|---|---|---|
| M₀ | Torque on ratchet wheel | At least 33N · m | |
| M₁ | Torque on motor 1 | At most 30.5N · m | |
| M₂ | Torque on motor 2 | At most 30.5N · m | |
| F₀ | Force from pawl to ratchet wheel | At least 33N | |
| F₁ | Force from link 1 to rod | At least 118N | |
| F₂ | Force from link 2 to joint 1 | At least 126N | |
| L₀ | Length of rod | 0.3 | m |
| L₁ | Length of link 1 | 0.21 | m |
| L₂ | Length of link 2 | 0.41 | m |
| α₀ | Angle of pawl to ratchet tooth | 20 | degrees |
| α₁ | Angle of joint 1 | To be calculate | |
| α₂ | Angle of joint 2 | To be calculate | |
| R₀ | Radius of ratchet wheel | 0.1 | m |

| | | |
|---|---|---|
| G₁ | Weight of link 1 | 8N |
| G₂ | Weight of link 2 | 15N |

The force applied on rod satisfied the relationship described by Equation 1.

M₀=F₀R₀

F₀R₀ sec²(α₀)=F₁L₀ Equation 1

In Equation 1, the rod's turning angle was ignored since it only swept within a very small range (FIG. 7A). Since M₀ should be at least 33 Nm to unlock the door, the F₀ could be calculated from Equation 1. As a result, the minimum lift force from the robotic arm should be greater than 132 N.

The force and moment on the first link of the robotic arm satisfied the condition illustrated in FIG. 7B and described by Equation 2.

M₁−F₁L₁ cos(α₁)+½G₁L₁ cos(α₁)≥0 Equation 2

In Equation 2, −F₁ was considered as reaction force from rod to the first link. The α₁ needed to be small in order to keep the best contact between the robotic arm and rod. The robotic arm had the best lift efficiency when α₁=0, and Equation 2 was still held. Thus, the actuator in joint 1 was qualified for the task.

For the second link, a similar condition in Equation 3 was denoted.

F₂=G₁−F₁

M₂−F₂L₂ cos(α₁)+½G₂L₂ cos(α₂)≥0 Equation 3

The second link was longer than the first link, and so the α2 should be bounded to guarantee that the actuator in the second joint does not exceed the limit. Thus, the second link was denoted with Equation 4.

$$cos ( {α}_{2} ) \leq \frac{{M}_{2}^{max}}{{F}_{2} {L}_{2} - \frac{1}{2} {G}_{2} {L}_{2}} {α}_{2} \geq 58 ° \qquad Equation 4$$

This result indicated the effective working space of the robotic arm. The result also proved that the robotic arm could generate enough lift force to unlock the door within a certain angle range.

The overall demonstration of the robotic system is described in FIGS. 2A-2F. The mobile platform proceeded by grasping and positioning the wrench tool 18 on the wheel handle 20 (FIG. 2A). The combination of the UGV and robotic arm allowed proper positioning and fitting. The arm smoothly unlocked the door with the help of the wrench tool (FIG. 2B). Once the wheel handle turned, the robot removed the tool 18 and prepared to open the door (FIG. 2C). Then the gripper grasped the grip and pull the door with the help from the UGV (FIGS. 2D-E). Finally, the mobile platform made its way across the door threshold (FIG. 2F).

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above but is only limited by the claims, including all equivalents of the subject matter of the claims. The disclosures of all patents, patent applications, and publications cited herein are hereby incorporated herein by reference, to the extent that they provide procedural or other details consistent with and supplementary to those set forth herein.

What is claimed is:

1. A force application system for placement on and removal from an actuable latch with a robotic arm, the system comprising:
a driving pad configured for attachment to the actuable latch;
a force application mechanism configured to increase an input force to an amplified output force that is applied by the force application mechanism to the driving pad; and
a frame for engagement by the robotic arm.

2. The system of claim 1, wherein the force application mechanism comprises:
a ratchet wheel rotationally fixed to the driving pad;
a pawl engageable with the ratchet wheel to rotate the ratchet wheel in a first direction to apply the amplified output force to the driving pad; and
a rod coupled to the pawl to move the ratchet wheel in the first direction in response to the input force.

3. The system of claim 1, wherein the force application mechanism comprises a gear set with a first gear for receiving the input force and a second gear rotationally fixed to the driving pad to apply the amplified output force to the driving pad.

4. The system of claim 1, wherein the force application mechanism comprises a gear set with a first gear for receiving the input force and a second gear rotationally fixed to the driving pad to apply the amplified output force to the driving pad; and
a motor to apply the input force.

5. The system of claim 1, wherein the driving pad comprises a tooth for placement between radial spokes of the actuable latch.

6. The system of claim 1, wherein the driving pad comprises at tooth for placement between radial spokes of the actuable latch and a magnet.

7. The system of claim 1, further comprising the robotic arm, wherein the robotic arm comprises:
a platform with driving members for moving the platform along a surface; and
an actuator for moving the robotic arm.

8. A method, comprising:
attaching, with a robotic arm, a force application tool to an actuable latch on a closure, wherein the force application tool comprises a driving pad attached to the actuable latch, a force application mechanism operable to increase an input force to an amplified output force applied to the driving pad;
applying the input force to the force application mechanism;
moving the actuable latch to an unlocked position in response to the amplified output force; and
moving the closure with the robotic arm to open a pathway.

9. The method of claim 8, wherein the force application mechanism comprises:
a ratchet wheel rotationally fixed to the driving pad;
a pawl engageable with the ratchet wheel to rotate the ratchet wheel in a first direction to apply the amplified output force to the driving pad; and
a rod coupled to the pawl to move the ratchet wheel in the first direction in response to the input force.

10. The method of claim 8, wherein the robotic arm applies the input force.

11. The method of claim 8, wherein the force application mechanism comprises a gear set with a first gear for receiving the input force and a second gear rotationally fixed to the driving pad to apply the amplified output force to the driving pad.

12. The method of claim 8, wherein the force application mechanism comprises a gear set with a first gear for receiving the input force and a second gear rotationally fixed to the driving pad to apply the amplified output force to the driving pad; and
a motor to apply the input force.

13. The method of claim 8, wherein the driving pad comprises a tooth for placement between radial spokes of the actuable latch.

14. The method of claim 8, wherein the driving pad comprises at tooth for placement between radial spokes of the actuable latch and a magnet.

15. The method of claim 8, further comprising the robotic arm, wherein the robotic arm comprises:
a platform with driving members for moving the platform along a surface; and
an actuator for moving the robotic arm.
